(19) United States
(12) Patent Application Publication
(10) Pub. No.: US 2007/0108716 A1
(43) Pub. Date: May 17, 2007

(54) Trial bidirectional wheels, tires and vehicles

(76) Inventor: Donald E. Scruggs, Chino, CA (US)

Correspondence Address: Donald E. Scruggs, 4464 Walnut Ave., Chino, CA, 91710, US

(21) Appl. No.: 11/581,816

(22) Filed: Oct. 17, 2006

Related U.S. Application Data
(60) Provisional application No. 60/739,455, filed on Nov. 14, 2005.

(51) Int. Cl. B60C 11/00; B60G 3/00

(52) U.S. Cl. 280/124.117; 152/209.1; 280/209

(57) ABSTRACT

A vehicle, wheel and tire combination with multiple lead right and left hand spiral screw thread treaded tires capable of traversing all types of terrain from hard surfaces, through snow, sand, dirt, twilight area mud, deep mud, bogs and water, by pivoting the wheels and tires of the vehicle about vertical axis to take full advantage of tread design.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to tires made with spiraled screw thread treads and vehicles with the capability of switching or pivoting their wheels between having a rotating axis across the width of the vehicle in the normal vehicle rolling mode and having an alternate mode where the tire rotating axis is along the length of the vehicle to provide for the vehicle to use the tires to screw through various materials and yet maintain vehicle steerability in both modes.

### BACKGROUND OF THE INVENTION

Currently most all terrain vehicles (ATVs) and off highway recreational vehicles (OHRVs) are made for light duty travel over a wide range of dry or nearly dry land areas. ATVs and OHRVs are usually equipped with wide cross section pneumatic tires having special treads and or are equipped with tracks over wheels. Most of these ATVs and OHRVs can traverse rough dirt, packed sand and mildly rocky areas. They normally rely on a light footprint spreading their weight over a wide area and engaging and compacting many particles of the traversed material, i.e. snow, sand and dirt, to get traction. They can often traverse a short section of loose materials if they acquire speed and momentum before entering the material, but they are not normally useable on a continuous basis in water or any type of mud or snow over a few inches deep. Once the traversed material is deep enough that it can squeeze from under the tire and can no longer compact under the footprint of the vehicle, especially if the adhesion of the traversed material exceeds its cohesion and begins to stick to the tires and or tracks, the vehicle loses traction and bogs down.

Some other special vehicles, having wide, flat belts with cleats on their ground contact areas are built to be used on snow. By spreading the vehicle weight over a wide area of snow and generating forward thrust by the cleats working against the cohesion of the snow, they are able to move forward from a stopped position in all but the lightest snow. Once in motion they then rely on speed and momentum to cross over lighter snow and more difficult areas. The manufacturers of these types recommend that they not be used on terrain other than that covered by a several inch deep layer of snow.

A number of different types of vehicle are built to operate in liquid mud areas and water. These usually have large diameter tires or paddle wheels and special propellers for mud and muddy water. These types commonly rely on speed and momentum to get from firm terrain to water. What is called the twilight area, between firm terrain and water, provides little traction. In addition, the increasing flotation of the vehicle, as it enters the water reduces the vehicle footprint pressure on the wet terrain which reduces compaction of the loose particles and thus reduces traction. As a result, many slow moving vehicles bog down between where they can roll on firm ground and where they can float in water and begin to use their water propulsion systems.

Many types of powered water vehicles are made, ranging from boats with outboard motors to air boats. Boats with outboard motors are usually transported to water on a trailer and manually launched into the water directly from the trailer. Air boats are considered to be another type of water vehicle. They rely on spreading weight over a wide area of liquid mud and or water. These are usually boats with flat bottomed hulls and powerful engines driving large diameter aircraft type propellers. They skim over water and wet areas covered with mud and or vegetation and can be driven a few dozen yards onto dry areas if enough speed and momentum is first achieved on the wet environment. The engine and propeller noise is generally at a high level, making them obtrusive to persons seeking quiet and relaxing outdoor activity and difficult as a platform from which to hunt or observe nature.

Heavier duty commercial and military vehicles, made for off road use, regularly have large diameter tires or some form of metal tracks. They are commonly large and unwieldy and roadway travel is usually restricted. Although some in this category are designed to perform in water, the majority are not so equipped.

A number of other vehicles have been built with combinations of wheels, paddle wheels, tracks, flotation means and propelling devices for use on both land and water. One such vehicle is an amphibian car, which looks like a small convertible with a propellor at the rear. Although it churns right along in water, its automotive size tires make crossing the muddy area between firm ground and a body of water difficult.

When a rubber tired vehicle is moving from a firm material environment, such as a road way, to a wetter environment such as a pond, bog or lake, the tires are known to load up with mud in the area between the firm material and the water. This loading of mud in the tire treads and on the tire causes the tire to begin to lose traction and spin free and not move the vehicle in the desired direction. This effect is known to be because the adhesion of the mud to the tire is greater than the cohesion of the mud to itself. The vehicle then needs some sort of special assistance to get to the water or at least get out of the mud. Once the mud is crossed and the vehicle is in the water, a secondary drive is needed as regular off-road pneumatic tires do not grip the water enough to provide traction.

The comfort of riding in a vehicle having flexible rubber or synthetic rubber pneumatic tires over a vehicle having tracks or solid wheels is well known and desirable. Pneumatic tires usually perform well on firm surfaces and, with proper shape, tread design and inflation pressure, and can be made to perform satisfactorily on some loose materials and shallow mud. They do not usually perform well in deep snow, fine particulate silty and slimy mud, water and loose sand. They usually just spin in most of these mediums and do not move the vehicle.

Close spaced cleats on tracks, such as used on military tanks, cause a very hard and relatively uncomfortable ride on firm ground and are known to bog down in snow, loose sand and silty, slimy, mud. Open spaced tracks, such as used on arctic and swamp vehicles provide an even more uncomfortable ride on firm surfaces and are very difficult to handle on highways.

Another class of very specialized vehicles is that of the screw pontoon vehicles. These vehicles usually have rotating pontoons with single lead screw threads around their exterior for the purpose of threading or screwing their way through slippery materials. In this design the threads on the left hand and right hand pontoons are made with opposite screw direction leads and rotated in opposing directions to balance the propulsion forces. The screw threads usually have a pitch length equal to the desired distance to be traveled during each revolution of the threaded pontoon. The pontoons literally screw the vehicle through mud, snow and or water. They are steered by slowing one pontoon and or increasing the speed of the other. Their advantage is that the slippery material to be traversed, especially sticky mud, tends to slide along the side surfaces of the threads and not pack up between the threads as happens with rolling treads on a mud tire. These screw pontoon types of vehicles have been successful in specific materials, but are generally unmanageable on firm surfaces, especially roadways.

### OBJECTS OF THE INVENTION

It is a main object of this invention to provide a vehicle having a comfortable ride on flat, rocky and sloped terrain and which can be adjusted to traverse sand, snow and all types of mud, including extremely slippery or slimy mud, and flat water.

It is another object of the invention to provide several types of wheel and tire configurations to be used on a variety of special vehicles to provide means for these vehicles to traverse all types of near level land and watery surfaces.

It is yet another object of the invention to provide mechanisms and vehicle configurations to effect switching the rotation of the wheels and tires of a vehicle from being at right angles to the length of the vehicle to being parallel to the length of the vehicle.

### OPERATING PRINCIPALS AND PREFERRED EMBODIMENT

The Tiral vehicle and pairs of Tiral tires comprise tires made with multiple lead thread treads, similar to multiple lead screws, spiraling parallel around a central axis, with the tires mounted and driven so they can be operated as rolling tires on firm surfaces and made to pivot approximately ninety degrees and be operated as screw threads to screw through materials which are loosely held together and materials having an amount of liquidity. By this arrangement when the tires are rolled about their central axis on flat surfaces, the tire contact with the surface is spread across a number of the closely spaced, spiraled thread treads causing a smooth ride within the vehicle. When the vehicle enters a loose particle material, such as soft sand, snow, mud and water, the central axis of the Tiral tire is pivoted approximately ninety degrees from its rolling axis and the screw thread treads screw the Tiral tire through these materials. Tiral tires are designed to be rounded, similar to a ball, to be square sided with a wide level rolling surface, similar to high-flotation tires or to be football shaped, with tapered ends, depending upon their intended purpose. Some designs perform more efficiently than others under specific conditions.

Tiral tires are installed in pairs, with tires on opposite sides of a vehicle having opposite spiraling thread treads and are made to turn in opposite directions, appropriate to the screw thread tread spiral, when in the screw mode and to rotate in the same direction when in roll mode. This design is preferred to avoid the need to change rotation direction as the tires are pivoted between roll mode and screw mode. (Refer to FIGS. 1 and 2.) On certain vehicle designs a tire rotation direction change is required, because of screw thread tread spiral direction, when switching between roll mode and screw mode.

The screw thread treads of Tiral tires are deep enough to push the vehicle in the required direction when in the screw mode, and also have enough space between them to allow them to slip through mud without having the mud build up between the screw threads.

The measurement from the top of one spiraled thread tread to the top of that thread tread where it continues around the tire and arrives at a point 360-degrees further around the tire is referred to as lead, which is occasionally called thread pitch.

By incorporating multiple leads, and with a lead of a single thread having sufficient length to provide the desired speed per revolution, preferred speed and force is achieved in both roll mode and screw mode. It has been found that most Tiral tires on medium duty vehicles will be generally efficient in both the roll mode and screw mode if the peak to peak of a single thread tread distance is about equal to the outside diameter of the tire.

Closely spaced multiple lead thread treads provide for a more comfortable ride by allowing a smoother transition from the top of one spiral to the next when in roll mode. This effect is most achieved in wide Tiral tires which have their spiral thread treads level from side to side.

Tiral wheels and tires roll in the conventional manner, spreading the contact over a number of spiraling screw thread treads, which are spaced so that there is a relatively imperceptible vehicle load transfer between tread peaks. Tiral vehicles are configured to pivot Tiral wheels and tires approximately ninety degrees about their vertical axis so that each Tiral tire can be used to screw its way, and the vehicle, through loose materials, mud and water.

With the proper arrangement of gearing and mechanical, hydraulic or electric drives a Tiral vehicle with Tiral tires can also be made to roll sideways on many surfaces.

Pairs of Tiral tires are used on a wide variety of Tiral vehicles, from three wheeled, with left hand and right hand thread treaded Tiral tires and a neutral wheel, to Tiral vehicles with any number of paired Tiral wheels and tires.

The preferred embodiment of the Tiral system is a vehicle with two flexible material left hand thread tread Tiral tires on one side and two flexible material right hand thread tread Tiral tires on the other, with conventional type steering on the front wheels and having the ability to pivot all four wheels between roll mode and screw mode. Flexible material Tiral tires provide a smoother ride as the treads bend as they come in contact with the surface.

### DESCRIPTION OF FIGURES.

FIG. 1 is a diagram of a four wheel Tiral vehicle in screw configuration, with hull outline, 107, showing the direction of travel, 101, the rotation, 100, of the left hand Tiral tires, 103 and 105, and the rotation, 102, of the right hand Tiral tires, 104 and 106. Note that the tires on the left have screw threaded treads opposite to that of the tires on the right side.

FIG. 2 is a diagram of the same four wheel vehicle as in FIG. 1, except that the Tiral tires have been pivoted to operate in roll configuration, with hull outline, 107, vehicle direction, 101, direction of left hand Tiral tire rotation, 100, left hand Tiral tires 103 and 105, direction of right hand Tiral tire rotation, 102, and right hand Tiral tires 104 and 106. Note that the left hand Tiral tires in FIG. 2 have ben pivoted clockwise and the right hand Tiral tires have been pivoted counter clockwise from their positions in FIG. 1, which maintains their original drive rotation.

FIG. 3 is a side view of a six wheel vehicle in roll configuration with a steering wheel, 110, hull, 111 , typical wheel pivot, 112 and typical tire, 113. Note that the vehicle is skid steered and has its center tire, 113, positioned lower than the front and rear tires to ease steering. FIG. 4 is a view from the rear of the vehicle in FIG. 3, with steering wheel, 110, and hull, 111, marked and with its transom removed to show a wheel pivot, 112, by which the tires are pivoted from roll mode to screw mode. Note that the left hand and right hand tires are somewhat football shaped and have opposite screw thread treads to balance the forward rolling of the vehicle and the screwing effect when they are pivoted to the FIG. 3 configuration.

FIG. 5 is a diagram of the same vehicle as shown in FIG. 3 and FIG. 4, with hull outline, 111, and showing the football shaped tires configured in roll position, with the left hand tires, 115, having opposite spiraling treads to the right hand tires, 114.

FIG. 6 is a side view of the same vehicle as in FIGS. 3, 4 and 5 with steering wheel, 110, and hull, 111, except that the near side of the vehicle is removed to show a typical pivot, 112, and the tires are pivoted into screw configuration.

FIG. 7 is an end view of the vehicle in FIG. 6, with steering wheel, 110, and hull, 111, with its transom removed to show typical wheel pivots, 112, and further illustrate that the left hand Tiral tires, 115, have their screw thread treads in an opposite direction to the right hand tires, 114.

FIG. 8 is a diagram of the same vehicle as shown in FIGS. 6 and 7, with a hull, 111, right hand Tiral tires, 114, with spiral treaded treads opposite and rotating in an opposite direction to the left hand Tiral tires, 115.

FIG. 9 is a side view of a four wheel vehicle with its near side removed to show a typical wheel pivot, 123, a hull, 120, left hand tires, 121, and a dropped section, 122, in the middle of the hull for added buoyancy in water.

FIG. 10 is a rear view of the same vehicle as in FIG. 9, with hull, 120, and with its transom removed to show a typical wheel pivot, 123, and a wide, laterally straight surfaced multiple lead screw thread tread Tiral tire, 121, on the left side and a similar, but opposite screw thread Tiral tire, 124, on the right side.

FIG. 11 is a side view of the same vehicle as in FIG. 9, with hull, 120, and the side removed to show a wheel pivot, 123, and both tires, 121, pivoted into screw mode.

FIG. 12 is the same view as in FIG. 10, except that the wheels and tires have been pivoted as in FIG. 11, and noting that the left hand tires, 121, have opposite direction screw thread treads to the right hand tires, 124. The dropped center of the hull is also shown, 122.

FIG. 13 is a diagram of a four wheel vehicle, shown in roll mode, having conventional automotive type steering in addition to being able to switch between roll and screw mode by way of its pivots (not shown). Note the direction of the vehicle, 133, and that the right front wheel, 131, is turned less than the left front wheel, 134, and the right rear wheel, 132, and left rear wheel, 135, do not turn, while lines drawn through the center rotating axis of all four wheel meet at the turning point, 136, in the fashion of standard automotive Akerman Steering.

FIG. 14 is a diagram of a two-chassis articulated vehicle steering system having a front chassis, 125, and a rear chassis, 126, a center pivot point, 128, a right hand cylinder, 127, and a left hand cylinder 130, which are opened and or closed to effect steering as shown in FIG. 15.

FIG. 15 is a diagram of an eight wheel articulated steering vehicle with a center pivot point, 128, marked (reference FIG. 14), a front chassis, 125, and rear chassis, 126, illustrating that all Tiral tires on the right side, 137, have opposing screw thread treads to the Tiral tires on the left hand side, 138, to balance the forward motion of the vehicle when in roll mode and when the Tiral wheels and tires are pivoted and the vehicle is in the screw mode.

FIG. 16 is a side view of a six wheel vehicle having a hull, 142, steering wheel, 143, with its side removed to show wheel pivots, 144, and screw threaded treads on the left side tires, 145.

FIG. 17 is a rear view of the same vehicle as in FIG. 16, with part of its transom removed to show wheel pivots, 144, steering wheel, 143, and illustrating that the left hand tires, 145, have screw threads opposite that of the right hand tires, 146.

FIG. 18 is a side view of the same vehicle as in FIG. 16, above, with its hull, 142, and steering wheel, 143, and having its Tiral wheel and tire pivots, 144, activated to put the Tiral wheels and tires, 145, into screw mode.

FIG. 19 is an end view of the vehicle in FIG. 18, similar to FIG. 17, above, showing the vehicle with part of its transom removed to illustrate wheel and tire pivots, 144, which have been pivot switched to put the tires in screw mode and noting that the left side tires, 145, are made with opposite screw thread treads to that of the right side tires, 146.

FIG. 20 is a diagram of a six wheel vehicle in screw mode, with four of its wheels, right front, 149, right rear, 151, left front, 152, and left rear, 154, turned and its two center wheels, 150 and 153, not turned and showing that the center lines through all wheels converge at a point, 147, to cause the hull,148, of the vehicle to make a turn around that point. Note that the left hand tires and the right hand tires are made with opposite spiraling screw thread tread direction.

FIG. 21 is an isometric illustration of a mechanism for switching a wheel and tire, 160, between roll mode and screw mode, by way of the pivot shaft, 155, being actuated by rotating the lower tube, 158, (See FIGS. 43 to 46), which is mounted between the upper chassis member, 156, and attached to the hull, 161, by the bearing, 159, with steering in both roll and screw mode provided by way of the upper tube, 157.

FIG. 22 is an isometric phantom sketch of a four wheel Tiral vehicle in its screw mode, with a hull, 170, an engine, 171, a engine driven hydraulic power supply, 172, which feeds power to the wheels, 173, with the wheels and tires of the vehicle pivoted by way of a pivot control tube, 175, and is steered in both roll and screw mode by way of the steering control tube, 174.

FIG. 23 is an isometric phantom sketch of the same four wheel Tiral vehicle as in FIG. 22, except it is in a roll mode, with wheel, 173, pivoted and having the same hull, 170, engine, 171, hydraulic power supply, 172, which feeds power to the wheels, 173, showing a right side pivot tube, 176, and noting its left side pivot control tube, 178, and steering control tube, 177.

FIG. 24 is an isometric phantom sketch of a six wheel vehicle, shown in screw mode, with the rolling axis of its tires, 184, aligned fore and aft along the hull, 180, and having an engine, 181, driving a hydraulic power supply, 182, which in turn drives hydraulic motors in each wheel, not shown, (see FIG. 50) and also pointing out a wheel pivot, 185, a steering tube, 186 and a pivot control tube, 187. (See FIGS. 47 to 50 for hydraulic diagram).

FIG. 25 is anisometric phantom sketch of the same six wheel vehicle as shown in FIG. 24, except in a roll mode, with the rolling axis of its wheels and tires, 184, cross wise of the vehicle (vehicle rolling mode), and pointing out for reference its hull, 180, engine, 181, and hydraulic power supply, 182, which in turn drives hydraulic motors in each of the six wheels (see FIG. 50).

FIG. 26 is a top view of a three wheel vehicle in roll mode, with its two front wheels being a balanced pair of Tiral round shaped tires showing the left hand tire, 191, with a left hand, multiple lead screw thread tread and the right hand tire, 193, with a right hand, multiple lead screw thread treads. Also shown are the vehicle power supply, 190, handle bars, 192, an operator seat, 195, and a large flotation tire, 195, at the rear.

FIG. 27 is a side view of the three wheel vehicle in FIG. 26, in roll mode, pointing out its power supply, 190, handle bars, 192, the right hand Tiral tire, 193, a large flotation tire, 194, and an operator seat, 195.

FIG. 28 is a rear view of the same three wheel vehicle as in FIGS. 26 and 27, showing its left hand Tiral tire, 191, its right hand Tiral tire, 193, a large flotation tire, 194, on the rear and an operator seat, 195.

FIG. 29 is a top view of the same three wheel vehicle as in FIG. 26, excepting that it is in screw mode with its left hand Tiral tire, 191, having its thread treads spiraling to the left and rotating to the left and its right hand Tiral tire, 193, having its thread treads spiraling to the right and rotating to the right to achieve balanced forward motion. Also shown are the handle bars, 192, rear flotation tire, 194, and the operator seat, 195.

FIG. 30 is a side view of the vehicle in FIG. 29, showing its right hand Tiral tire, 193, in screw mode and rotating opposite the left hand Tiral tire, not shown. Also shown are the handle bars, 192, rear flotation tire, 194, and the operator seat, 195.

FIG. 31 is a rear view of the vehicle in FIG. 29 and 30, in screw mode, with the left hand Tiral tire, 191, rotating counter clock wise and the right hand Tiral tire, 193, rotating clock wise. Also shown are handlebars, 192, a large flotation tire, 194, at the rear and an operator seat, 195.

FIG. 32 is an isometric phantom view of a three wheel vehicle in roll mode, similar to those shown in FIGS. 26 to 31, except with wider tires, pointing out for reference its power supply, 190, handle bars, 192, rear flotation tire, 194 an operator seat, 195, and showing a chain drive, 200, feeding from a center shaft, 204, to a left hand pinion and gear drive, 201, and a right hand pinion and gear drive, 202, which sends the motion down vertical shafts to right angle gear drives, 203, to the wheels, 205 and 206.

FIG. 33 is an isometric phantom view of the same vehicle shown in FIG. 32, except in screw mode, pointing out for reference its power supply, 190, handle bars, 192, rear flotation tire, 194, operator seat, 195, and showing a chain drive, 200, to a left hand pinion and gear drive, 201, and a right hand pinion and gear drive, 202, which sends motion down vertical shafts and right angle gear drives to the wheels, 205 and 206.

FIG. 34 is a top view of a three wheel Tiral vehicle in roll mode with its Tiral driving wheels at the rear, showing a large flotation tire, 210, in the front, handle bars, 211, and power supply, 215, in the middle and an operator seat, 214 at the rear and having a right hand spiraled thread tread Tiral tire on the left, 212, and a left hand spiraled thread tread Tiral tire on the right, 213.

FIG. 35 is a side view of the three wheel vehicle in FIG. 34, showing its flotation front tire, 210, handle bars, 211, power supply, 215, operator seat, 214, and a side view of a right hand Tiral tire, 213.

FIG. 36 is a rear view of the vehicle shown in FIGS. 34 and 35, with handle bars, 211, and operator seat, 214, noted for reference, and having a left hand wheel arch pivot, 217, and a right hand wheel arch pivot, 218, at the ends of a cross beam, 216, with a wheel arch, 219, over the left hand Tiral tire, 212, and a separate wheel arch, 220, over the right hand Tiral tire, 213. Note that matched pairs of Tiral tires with opposite spiraling screw thread treads are used to balance the forward thrust of these vehicles in both the roll and screw modes.

FIG. 37 is a top view of the same vehicle in FIG. 34, excepting that the vehicle is in screw mode, showing for reference the flotation tire, 210, at the front of the vehicle and a wheel arch, 219, over the left side Tiral tire, 212, which has right hand spiraled screw thread treads and rotates clock wise, and a wheel arch, 220, over the right side Tiral tire, 213, which has left hand screw thread treads and rotates counter clock wise.

FIG. 38 is a side view of the vehicle in FIG. 37,.in screw mode, showing a cross beam, 216, a right side wheel arch, 220, over a right side Tiral tire, 213, which has a screw thread tread spiraling opposite that of the Tiral tire on the left side.

FIG. 39 is and end view of the vehicle shown in FIGS. 37 and 38, in screw mode, having a left side wheel pivot, 217, a right side wheel pivot, 218, a left side wheel arch, 219, over a left side Tiral tire, 212, and a right side wheel arch, 220, over a right side Tiral tire, 213.

FIG. 40 is an exposed isometric view of a drive train normally housed within the cross beam (shown as item 216 in FIGS. 36 and 39) and within the wheel arches, 219 and 220 (in the same illustrations) pointing out the chain drive, 223, from the power supply, typical right angle gear drives, 224 and 226, vertical shafts, 225, around which wheel pivoting occurs, and individual wheel drive shafts, 227 and 228.

FIG. 41 is an isometric view of only the rear of a typical vehicle shown in roll mode, with its left side driving wheel, 212, and its right side driving wheel, 213, its wheel arches, 219 and 220, its cross beam, 216 (inside of which is housed the gear sets shown in FIG. 40) and the mode switching mechanism, 222, by which the Tiral wheels and tires are pivoted by way of their respective wheel arches and the vehicle is switched between roll and screw mode.

FIG. 42 is an isometric view of only the rear of the same vehicle as shown in FIGS. 41, excepting that it is in screw mode, showing its cross beam, 216, which contains the gear sets shown in FIG. 40, and a left side Tiral driving wheel, 212, and a right side Tiral driving wheel, 213, wheel arches, 219 and 220, and the switching mechanism, 222, by which the Tiral wheels are pivoted by way of their respective wheel arches and the vehicle is switched between roll and screw mode.

FIG. 43 is a cross section cut away view of a Tiral pivot, steering and mechanical wheel drive unit as used on several of the Tiral vehicles shown herein. It is attached to the vehicle at the top by way of the flange, 230, and at the bottom by way of the mount, 242. A power drive shaft, 233, has a right angle gear set, 245, within a wheel arch, 255, and a horizontal drive shaft, 246, taking the motion to a Tiral wheel (not shown) through additional right angle drives and or chains (also not shown). The wheel arch mount, 241, holds the wheel arch to the vehicle hull, 244, by way of the bearings shown, but not numbered. The entire pivot steering and drive mechanism is tied together so that when the pivot is switched between roll mode and screw mode the steering mechanism moves relative to the switching pivot mechanism, making the unit steerable in either mode. To steer the vehicle a steering control device, such as a steering wheel, lever or handle bar, rotates the steering tube, 235, which moves arms, 234, which have rollers, 232, near their ends, fitted into a pair of flanges extending outward from a steering ring, 239, (note the threaded adjustment on the steering ring to reduce play between the rollers and the ring flanges) and moves the steering ring, 239, up and or down, causing it to rotate a steering shaft, 231, by way of ears fitted into spiraled slots, which extends to and is attached to the wheel arch, 255. To switch the pivot between roll mode and screw mode, the switching tube, 236, is rotated, which in turn moves arms, 237, attached to it and through pins, 238, on a switching ring, 229, causing the switching member, 243, to rotate, by way of ears fitted into spiraled slots, and pivot between the two modes. Note that a spline between the switching member, 243, and the steering ring, 239 keeps the two members in relative rotary position.

FIG. 44 is a cross section cut away side view of the pivot, steering and mechanical wheel drive unit shown in FIG. 43, pointing out the top mounting flange, 230, the steering member, 231, which is driven by the steering ring, 239, the power drive shaft, 233, the steering arm, 234, attached to the steering tube, 235, the roll to screw mode switching tube, 236, and its attached arm, 237, which drives the roll to screw mode switching ring, 240. Also shown are the lower mounting flange, 242, the roll to screw mode switching member, 243, the wheel arch mount, 241, the vehicle hull, 244, and the right angle gear drive, 245, inside the wheel arch, 255.

FIG. 45 is a side view showing the relationship of the steering tube, 235, an attached arm, 234, and the roller, 232, which fits into a steering ring on a roll to screw mode switch and pivot mechanism. Also shown is a mode switching tube, 236, an attached arm, 237, and a slide, 238, with a hole which fits over a protruding pin on a roll to screw mode switch and pivot mechanism (Refer to FIGS. 43 and 44).

FIG. 46 is an isometric sketch of a typical steering and mode switching layout, pointing out a power drive shaft, 233, through an upper flame member, not numbered, a steering tube, 235, a mode switching tube, 236, a steering wheel, 247, steering linkage, 248, a steering tube control arm, 249, a roll to screw mode switching lever, 251, a roll to screw mode switching control tube arm, 250, a steering tube, 252, a switching tube, 253, a pivot member, 254, a wheel arch, 256, over a left side Tiral wheel, 257, and a right side Tiral wheel, 258.

FIG. 47 is a schematic diagram of a hydraulic system used to drive six wheels of a Tiral vehicle with a power unit, 262, driving a hydraulic power supply, feeding six hydraulic motors, 264, through control valves. Also shown is a direct coupled hydraulic steering mechanism, 263, where a steering gear pushes hydraulic pistons which in turn move pistons in remote cylinders.

FIG. 48 is a schematic diagram of a hydraulic system used to power four hydraulic motors driving Tiral wheel assemblies, as shown in FIG. 50, or used to power other driving units, such as chain or gear sets, powering various types of Tiral wheels and tires. Also shown is a direct coupled steering mechanism, not numbered.

FIG. 49 is a schematic diagram of a hydraulic system used to power two hydraulic motors driving Tiral wheel assemblies, as shown in FIG. 50, or used to power other driving units, such as chain or gear sets, powering wheels on opposite sides of a vehicle for a skid steering arrangement. Also shown is a direct coupled steering mechanism, not numbered.

FIG. 50 is a cut away view of a roll to screw mode pivoting and steering hydraulic powered Tiral wheel arrangement with hydraulic hoses, 265, feeding into the top of a steering tube, 266, which is inside a pivot tube, 260, a steering arm, 267, attached to the steering tube, 266, a wheel arch, 269, over a Tiral wheel and tire, 270, a hydraulic motor, 271, a wheel shaft, 272, inside of a bearing and a coupling shaft, 273, attaching the output shaft of the hydraulic motor, 271, to the wheel shaft, 272.

FIG. 51 is a cut away cross section of the outside layer of a Tiral tire showing the multiple lead spiraled screw thread treads, 275, and showing that the distance between individual screw threads, 276, should be about equal to or greater than the height of the screw thread treads, 277.

FIG. 52 is a cut away cross section of a Tiral tire having multiple lead spiraled screw threads, 278, a side wall, 279 and a beading, 280, similar to that of conventional tires.

FIG. 53 is a side view of multiple leads of a Tiral tire with a single spiraled screw thread tread, 283, highlighted, and the distance, 281, from the top peak of one of that single spiraled screw thread tread to the next top peak of the same spiraled screw thread tread. Having the distance between top peaks of a single lead, 281, approximately equal to the overall diameter of the Tiral tire, 282, causes the vehicle to travel in roll mode about three times faster than it will travel in screw mode which nearly compensates for the added rotational load and thus speed reduction for normal weight and capacity vehicles. Higher weight and capacity vehicles should be designed with shorter distance between top peaks of a single lead, 281, relative to the overall diameter of the Tiral tire, 282.

FIG. 54 is a side view of a Tiral tire, made in metal or a more flexible plastic or rubber, showing its diameter, 282, and its inside mounting diameter, 284, where a beading would be found which would fit snugly onto a wheel rim.

FIG. 55 is a side view of a wider Tiral tire (longer in screw mode) made in metal or a more flexible plastic or rubber, and highlighting a single screw thread tread, 288, showing the distance from one top peak of the highlighted single screw thread tread to the next, 285, which is usually designed to be approximately equal to the tire diameter, and also showing a driver shaft, 287.

FIG. 56 is an end view of a Tiral tire as shown in FIG. 55, noting its overall diameter, 286.

FIG. 57 is a phantom isometric view of a wheel and drive system for one side of a Tiral vehicle, with a differential gear, 294, a brake, 293, on one side and a brake, 295, on the other side which are used to stop the driving mechanism on one side or the other of the vehicle for skid steering. Also shown are a chain drive, 291, from a sprocket above the center wheel, which is fed by the chain drive, 292, from a right angle gear box, 297, which also operates a chain drive, 298, with another sprocket, 299, on the same shaft, feeding power to a right angle gear set, 300, inside a wheel arch, and through a chain drive, 301, turning a sprocket, 302, which ultimately turns a Tiral wheel and tire, 303. Also shown are an opposite side gearbox, 297, and a chain drive, 296, also on the opposite side.

FIG. 58 is an isometric view of a single Tiral wheel, tire, pivot, steering and driving assembly with a feed in drive shaft, 304, a roll to screw mode pivot tube, 305, a hydraulic steering cylinder, 306, (see FIG. 59) a roll to screw mode switching member, 307, a steering arm, 308, an arm, 309, on the roll to screw mode switching member, a hull mounted flange bearing, 310, a right angle gear set, 313, a wheel axle, 311, from the right angle gear set, and a Tiral wheel and tire, 312.

FIG. 59 a top view looking down on a roll to screw mode switching pivot and steering mechanism, showing roll mode in solid line “A”position and screw mode in dotted line “B” position, having a pivot arm, 309A and 309B, a hydraulic steering cylinder, 306A and 306B, which is mounted on the pivot arm and which changes the distance between the pivot arm to effect steering, and a steering arm, 308A and 308B relative to the pivot arm, 309A and 309B, controlling the steered position of a Tiral wheel and or tire, 312A and 312B.

FIG. 60 is a view looking down on a mechanical system which can be substituted for the hydraulic system shown in FIG. 59, where a cable housing, 318, is mounted with a swivel fitting, 317, on a pivot arm, 316A and 316B, and travels with the pivot arm as it changes position during switching between roll and screw mode and effects steering by changing the relative distance between a pivot arm, 316A and 316B, and a steering arm, 315A and 315B.

FIG. 61 is a view looking down on a Tiral unit designed to be added to a boat, vehicle or piece of equipment, showing a cross beam, 326, a roll to screw mode switching lever, 325, a switching lever lock, 322, switching linkage, 321, a typical switching arm, 324, attached to a wheel pivot, a left hand screw thread tread Tiral tire, 320, on the left in roll mode and a right hand screw thread tread Tiral tire, 323, on the right, also in roll mode.

FIG. 62 is a view looking down on the same unit as shown in FIG. 61, with a left hand screw thread tread Tiral tire, 320, in screw mode, and a right hand screw thread tread Tiral tire, 323, also in screw mode, with roll to screw mode switching linkage, 321, a switching lever, 325, a cross beam, 326, a left pivot arm, 324, and a right pivot arm, 328.

FIG. 63 is a view looking down on a cable operated steering mechanism used on the unit depicted in FIGS. 61, 62 and 64, where the cable housing, 331, is attached with a swivel, 333, to the switching arm, 334, and moves the steering arm, 330, relative to the pivot arm, 334, by way of the cable attachment, 332, to the steering arm. Note that dotted lines indicate the location of the two arms in the two different roll to screw mode switch modes.

FIG. 64 is a perspective view of a unit, such as shown in FIGS. 61 and 62, attached on a boat and showing its roll to screw mode switching linkage, 321, switching lever, 325, switching lever lock, 322, steering mechanism, 335, (such as that shown in FIG. 63) a right hand Tiral tire, 336, a left hand Tiral tire, 338, a steering and motor control console, 339, a electrical power pack, 340, and a stem mounted swivel wheel, 341, (two or more swivel wheels are used for heavier loads and better balance).

FIG. 65 is a cut away cross section of a round type Tiral wheel, tire, swivel and power assemble, with an electrical power input cable, 345, a cross beam, 346, an electric motor, 347, a gearbox, 348, and wheel attachment hardware, 349, shown.

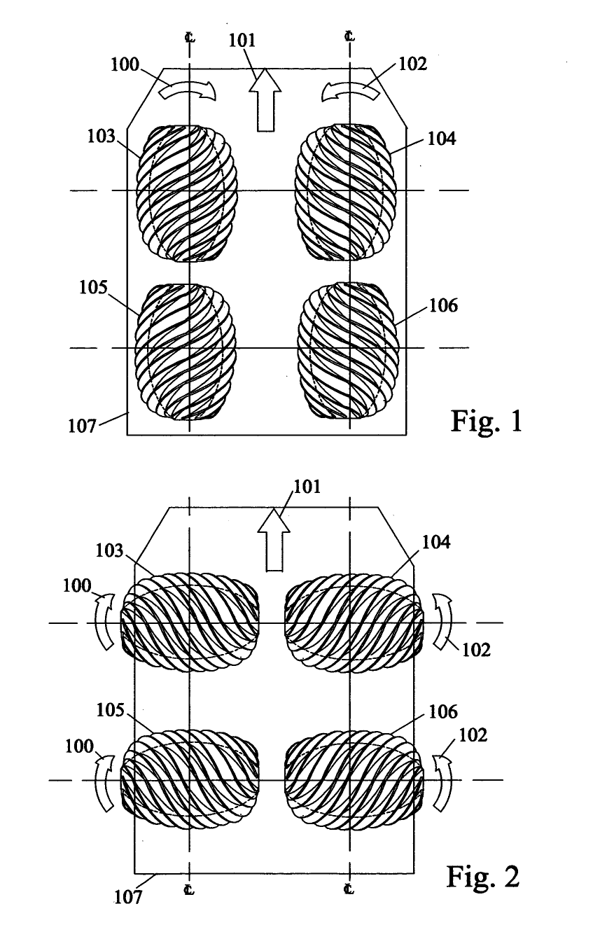

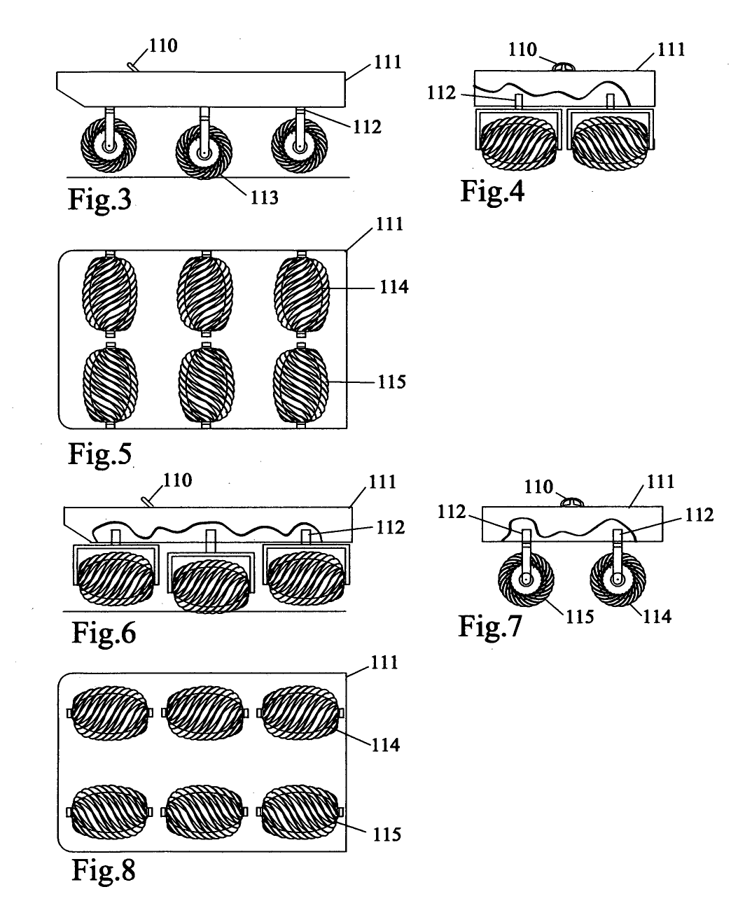

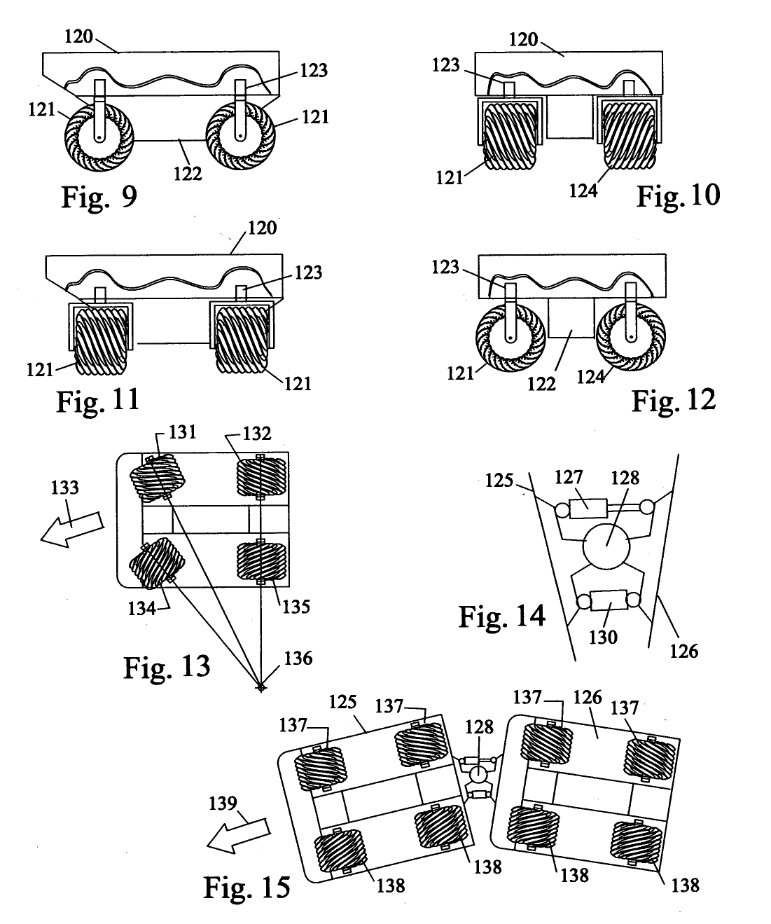

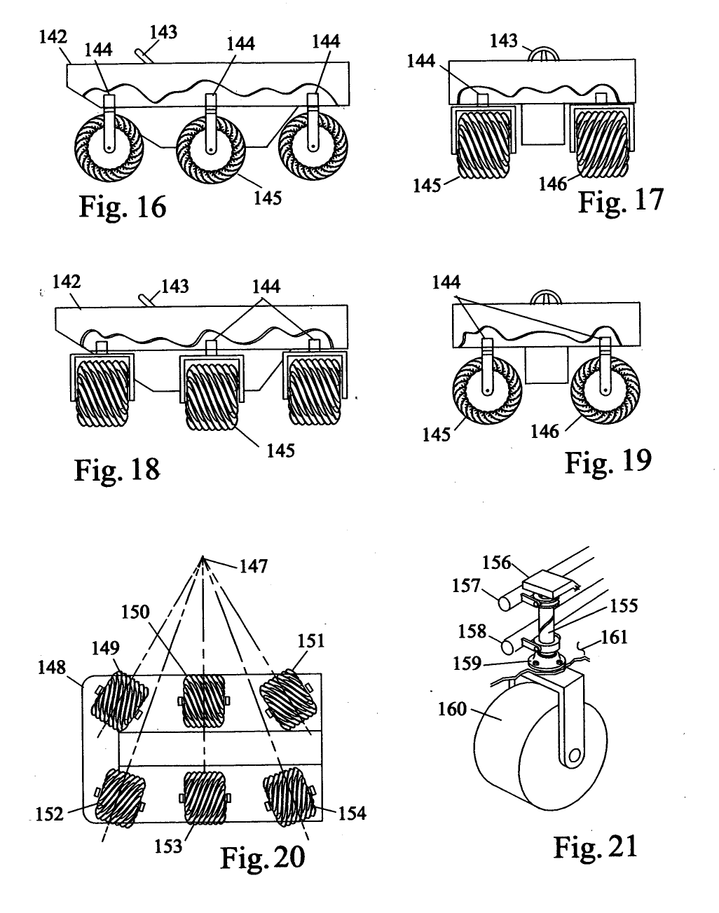

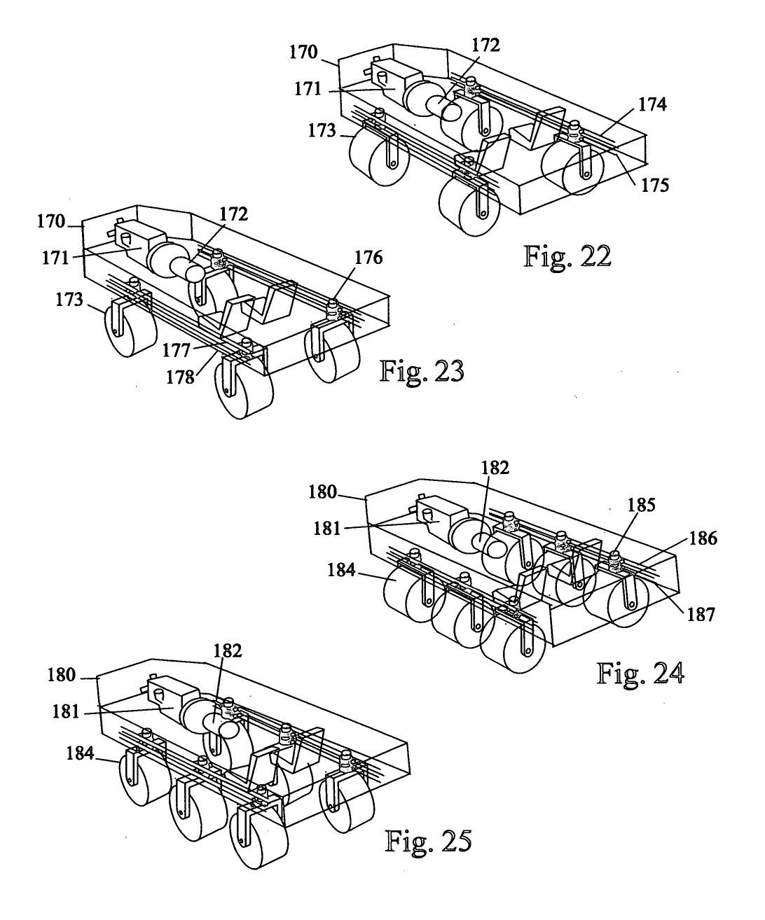

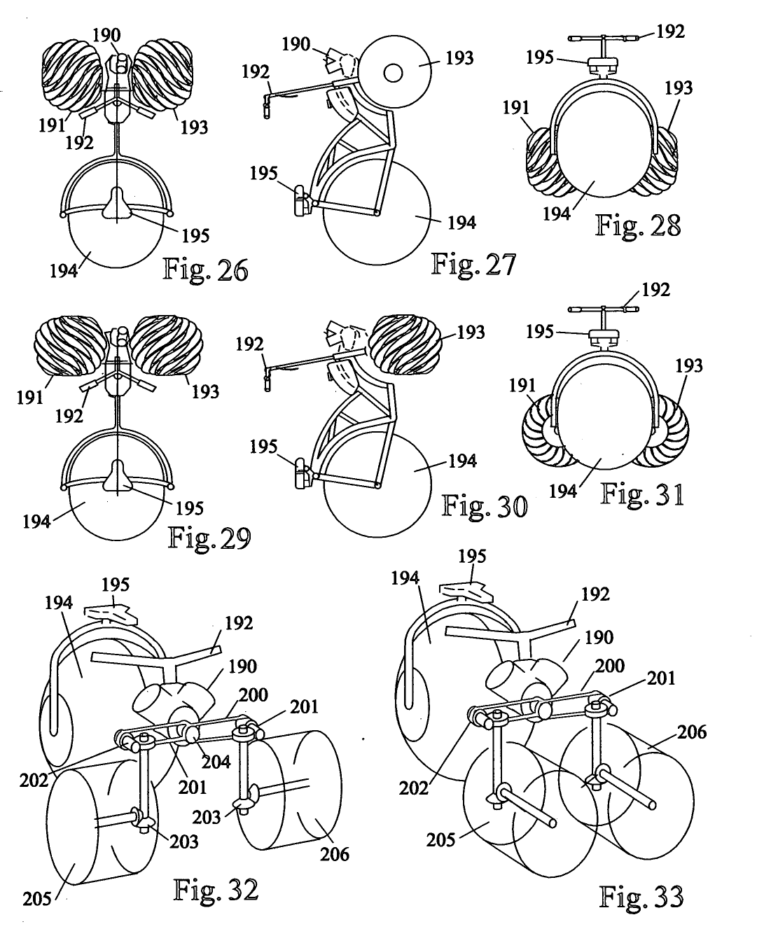

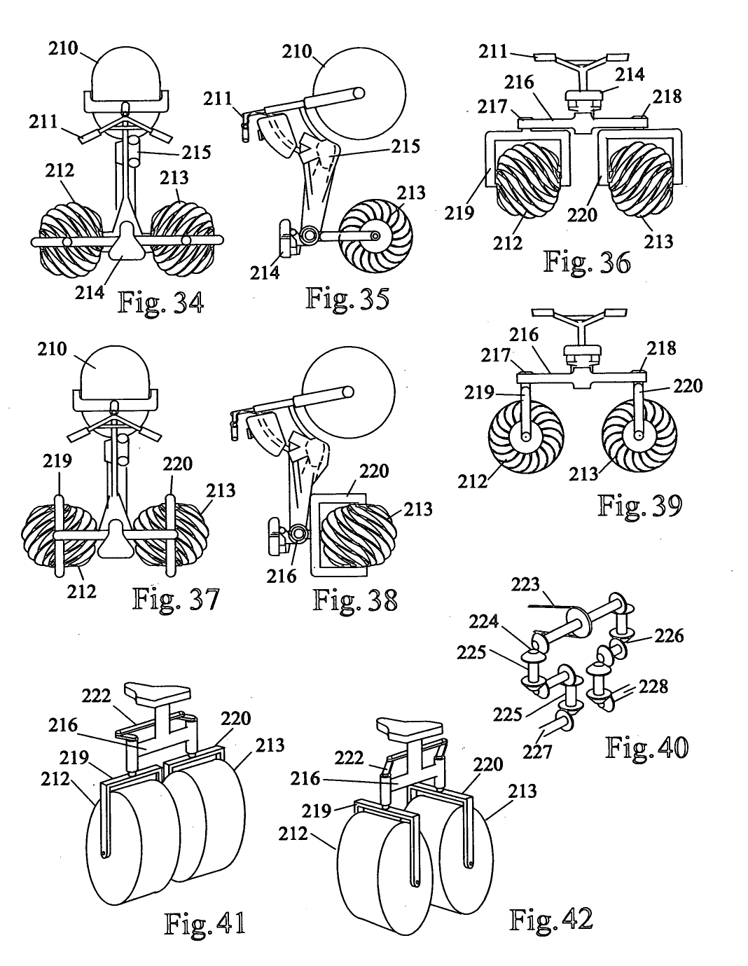

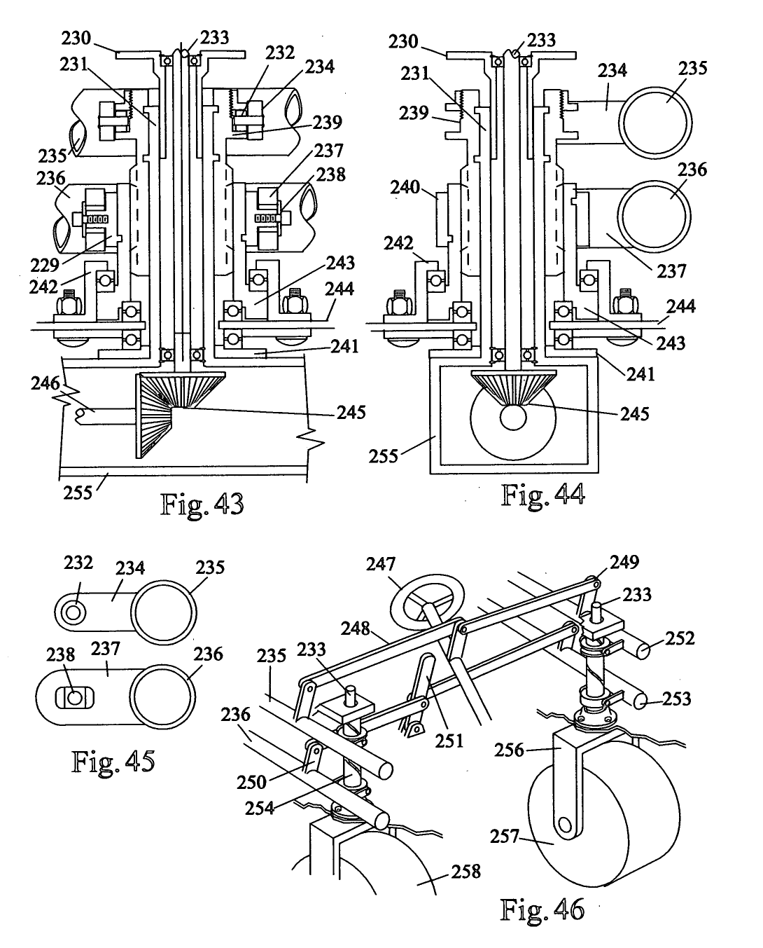

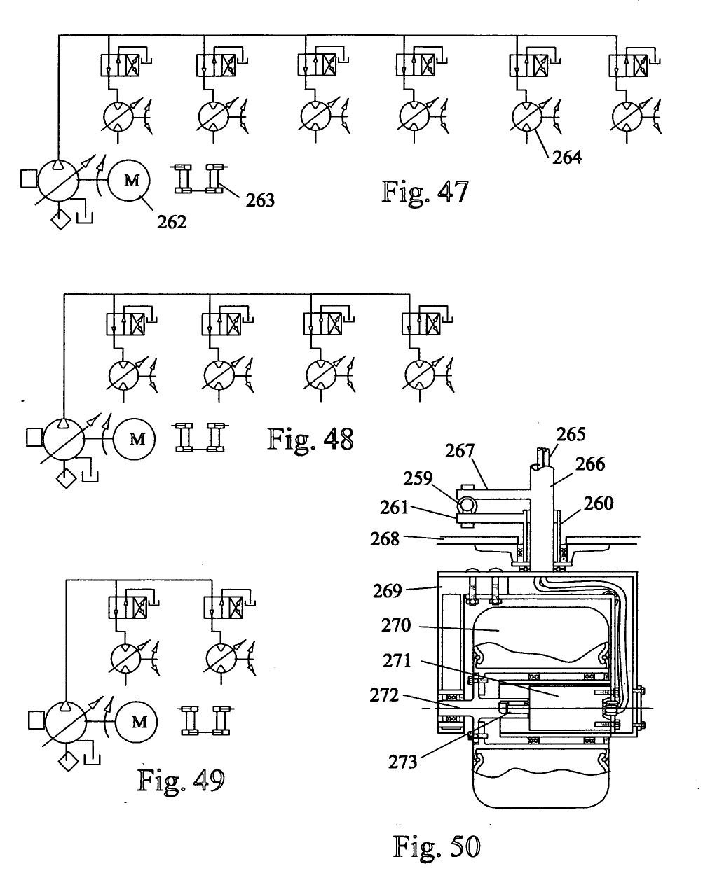

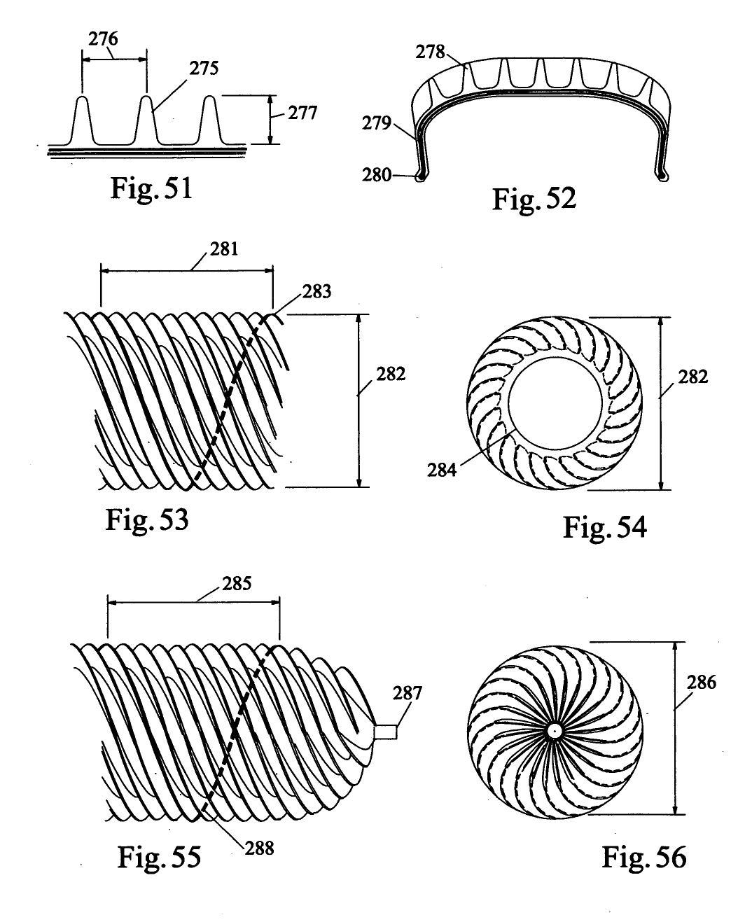

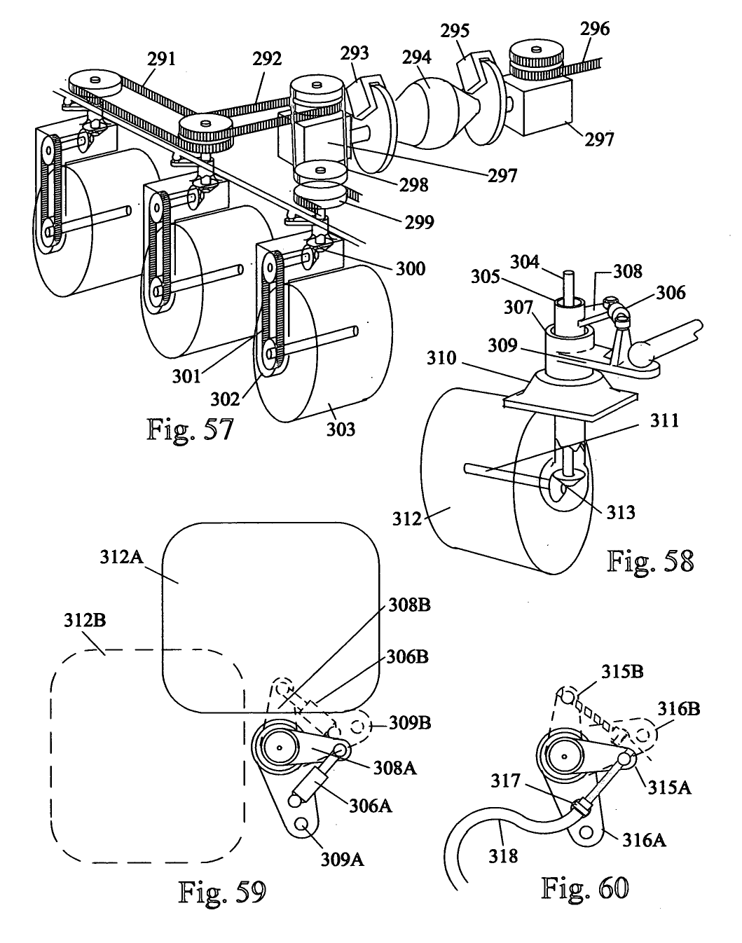

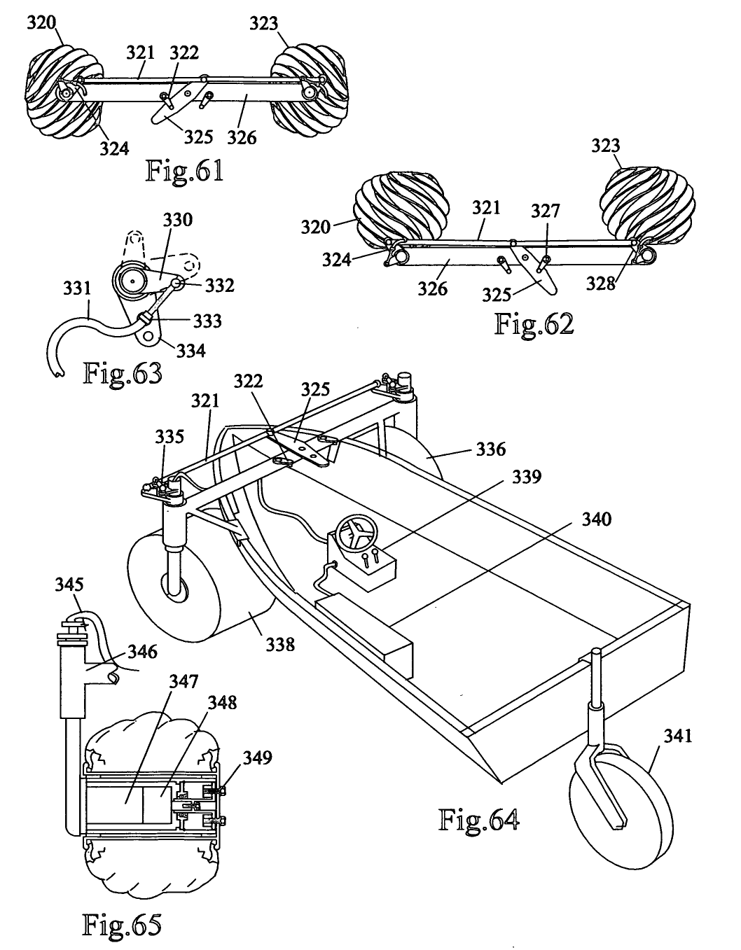

I claim:

1. A vehicle with spiraled screw thread treaded tires capable of pivoting its tires about vertical axis so as to allow the tires to roll in one mode and screw through materials in another mode.

2. A vehicle as in claim 1, having spiraled screw thread treaded tires on one side and oppositely spiraled screw thread treaded tires on the other side.

3. A vehicle as in claim 1, with mechanism and device providing for it to maintain steering through all points of vertical axis pivot.

4. A tire with spiraled screw thread treads extending from the surface of the tire and spiraling around and across the surface of the tire.

5. A tire as in claim 4, made in a round configuration, similar to the shape of a round ball.

6. A tire as in claim 4, made in a oval configuration, similar to the shape of a football.

7. A framework capable of pivoting its tires about vertical axis supporting spiraled screw thread treaded tires which can be attached to another piece of equipment to provide for that piece of equipment to traverse flat surfaces, loose material surfaces, mud surfaces and water.

8. A framework as in claim 7, having spiraled screw thread treaded tires on one side and oppositely spiraled screw thread treaded tires on the other side.

9. A framework as in claim 7, with mechanism and device providing for it to maintain steering through all points of vertical axis pivot.
